(19) United States
(12) Patent Application Publication
(10) Pub. No.: US 2025/0243591 A1
(43) Pub. Date: Jul. 31, 2025

(54) WATER ELECTROLYZER SYSTEMS

(71) Applicant: TOYOTA JIDOSHA KABUSHIKI KAISHA, Toyota-shi Aichi-ken (JP)

(72) Inventors: Makoto MORI, Sunto-gun Shizuoka-ken (JP); Tsuyoshi HAMAGUCHI, Nagakute-shi Aichi-ken (JP); Tomoyuki KAYAMA, Nagakute-shi Aichi-ken (JP); Ryo MASUDA, Nagakute-shi Aichi-ken (JP); Tadanobu UEDA, Nagakute-shi Aichi-ken (JP)

(73) Assignee: TOYOTA JIDOSHA KABUSHIKI KAISHA, Toyota-shi Aichi-ken (JP)

(21) Appl. No.: 19/013,112

(22) Filed: Jan. 8, 2025

(30) Foreign Application Priority Data
Jan. 30, 2024 (JP) 2024-011733

(51) Int. Cl. C25B 9/67; C25B 9/23

(52) U.S. Cl. CPC C25B 9/67; C25B 9/23

(57) ABSTRACT

A water electrolysis system capable of suppressing a decrease in durability of a water electrolysis cell by ensuring cooling of a water electrolysis cell is provided. In a water electrolysis system for obtaining hydrogen from a hydrogen electrode by supplying water to an oxygen electrode of a water electrolysis cell and applying a voltage to the water electrolysis cell, a cooling fluid path for supplying a cooling fluid different from that supplied to an oxygen electrode is provided to the water electrolysis cell by a flow path different from a flow path for supplying water to an oxygen electrode.

### CROSS-REFERENCE TO RELATED APPLICATIONS

This application is based upon and claims the benefit of priority of the prior Japanese Patent Application No. 2024-011733, filed on Jan. 30, 2024, the entire contents of which are incorporated herein by reference.

### FIELD

The present disclosure relates to a water electrolysis system.

### BACKGROUND

Patent literature 1 discloses that cooling water cooled by a radiator is circulated in a water electrolytic stack.

In Patent literature 2, it is disclosed that a countermeasure is taken for the influence of a bilayer flow in water electrolysis.

Patent literature 3 discloses that feed water to an anode electrode is cooled prior to stack feeding.

Patent literature 4 discloses that circulation of water to an anode electrode is continuously cooled at the time of stopping water electrolysis.

### CITATION LIST

### Patent Literature

Patent Literature 1: JP 2022-153049 A
Patent Literature 2: JP 2002-285368 A
Patent Literature 3: JP 2017-203203 A
Patent Literature 4: JP 2012-067343 A

### SUMMARY

### Technical Problem

At the outlet side of the oxygen electrode of the water electrolysis cell, the ratio of the oxygen gas to the supply water for water electrolysis accompanying the generation of oxygen increased, and the cooling effect by the supply water decreased with respect to the inlet side, so that it could not be said that the suppression of the temperature increase of the water electrolysis cell was sufficient. If the temperature of the water electrolysis cell increases too much, the durability of the water electrolysis cell decreases.

In view of the above problems, it is an object of the present disclosure to provide a water electrolysis system capable of ensuring cooling of a water electrolysis cell and suppressing a decrease in durability of a water electrolysis cell.

### Solution to Problem

The present application discloses a water electrolysis system in which hydrogen is obtained from a hydrogen electrode by supplying water to an oxygen electrode of a water electrolysis cell and applying a voltage to the water electrolysis cell, wherein the water electrolysis cell has a cooling fluid path for supplying a cooling fluid different from that supplied to the oxygen electrode by a second flow path different from the first flow path for supplying water to the oxygen electrode with respect to the water electrolysis cell.

The direction in which the cooling fluid flows may be configured to be in a countercurrent relationship to the direction in which the water supplied to the oxygen electrode flows.

The cooling fluid may be associated water discharged from the hydrogen electrode.

The cooling fluid may be water branched from a path for supplying water to the oxygen electrode.

The cooling fluid may be water supplied from a gas-liquid separator provided on the hydrogen electrode side.

In the water electrolysis system described above, the water electrolysis cell may have a separator on an oxygen electrode, and a first flow path may be formed on a first surface of the separator, and a second flow path may be formed on a second surface opposite to the first surface.

In the water electrolysis system described above, the first flow path and the second flow path may extend in parallel.

### Effects

According to the present disclosure, it is possible to suppress an increase in temperature in an outlet region of an oxygen electrode in which a ratio of oxygen gas is increased and a cooling effect is reduced by flowing a cooling fluid.

### BRIEF DESCRIPTION OF DRAWINGS

FIG. 1 is a plan view of the water electrolysis cell 10.

FIG. 2 is a cross-sectional view illustrating a layered structure of the water electrolysis cell 10 in the water electrolysis area 10a.

FIG. 3 is another cross-sectional view illustrating the layered structure of the water electrolysis cell 10 in the water electrolysis area 10a.

FIG. 4 is a conceptual diagram illustrating the structure of the water electrolysis stack 20.

FIG. 5 is a diagram illustrating a laminated structure of the water electrolysis cell 10 in the water electrolysis stack 20.

FIG. 6 is another view illustrating a laminated structure of the water electrolysis cell 10 in the water electrolysis stack 20.

FIG. 7 is a conceptual diagram illustrating a form 1 of the water electrolysis system 30.

FIG. 8 is a conceptual diagram illustrating the form 2 of the water electrolysis system 30.

FIG. 9 is a conceptual diagram illustrating a form 3 of the water electrolysis system 30.

### DESCRIPTION OF EMBODIMENTS

### 1. Water Electrolysis Cell

First, a configuration of a water electrolysis cell to be cooled will be described.

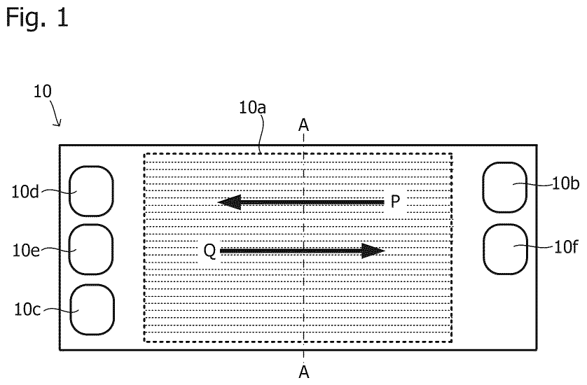

FIG. 1 shows a diagram illustrating the structure of the water electrolysis cell 10 according to one embodiment. The water electrolysis cell 10 is a unit element for decomposing pure water into hydrogen and oxygen, and a plurality of such water splitting cells 10 are laminated to constitute a water electrolysis stack to be described later. FIG. 1 is a plan view of the water electrolysis cell 10. In FIG. 1, in order to describe the internal structure of the water electrolysis cell 10, a part (especially the water electrolysis region) of the internal structure concerned is represented by the dotted line.

The principle of water electrolysis in the water electrolysis cell 10 is as known, but the outline thereof is as follows.

Pure water (feed water for water electrolysis) is supplied from an oxygen electrode introduction hole (oxygen electrode side inlet manifold) 10b and reaches a water electrolysis area 10a, where water electrolysis is performed.

In the water electrolysis area 10a, a portion of pure water is decomposed into oxygen and hydrogen by a water electrolysis membrane electrode assembly to be described later, and is discharged through the respective flow paths. Specifically, the generated oxygen and the remaining water electrolysis feed water are discharged from the oxygen electrode outlet hole (oxygen electrode side outlet manifold) 10c On the other hand, the generated hydrogen and the accompanying water move to the electrode (hydrogen electrode) opposite to the electrode (oxygen electrode) through which the water electrolysis supply water flows with the water electrolytic membrane electrode assembly sandwiched therebetween, and are discharged from the hydrogen electrode lead-out hole (hydrogen electrode side outlet manifold) 10d Both of the oxygen electrode and the hydrogen electrode are provided in the water electrolysis cell 10, but other than the water electrolysis area 10a, a respective flow path separated from each other is formed so as to be partitioned by a sealing member (not shown) so that the generated hydrogen and oxygen do not mix.

In this form, as will be described later, a cooling fluid is further configured to flow through a channel (cooling fluid channel 25) formed outside the oxygen electrode of the water electrolysis cell 10 when a water electrolysis stack is formed. The cooling fluid flows from the cooling fluid inlet hole (cooling fluid inlet manifold) 10e to cool the water electrolysis cell 10 oxygen electrode side, is discharged from the cooling fluid outlet hole (cooling fluid outlet manifold) 10f. Incidentally, the flow path through which the cooling fluid also is formed so as not to mix with each other by being partitioned from the flow path of the oxygen electrode and the hydrogen electrode.

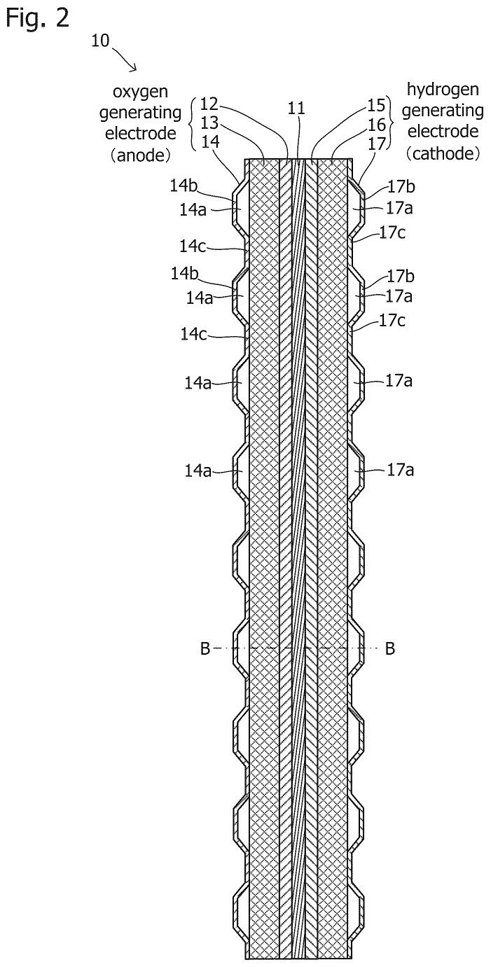

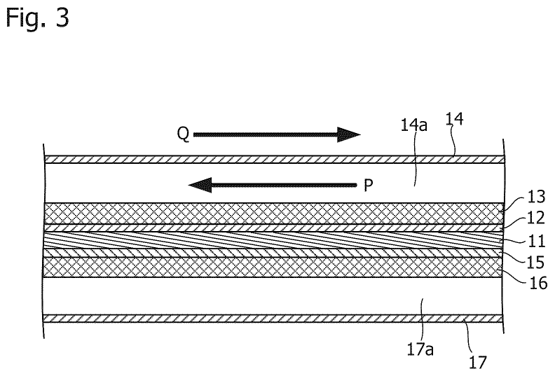

Hereinafter, a configuration of the water electrolysis cell 10 will be described. FIG. 2 is a cross section (cross section perpendicular to the flow direction) illustrating a layer configuration in a water electrolysis area 10a in which water electrolysis is performed among the water electrolysis cells 10 which is a part of the A-A cross section in FIG. 1. FIG. 3 is a B-B cross section of FIG. 2, and a cross section (cross section parallel to the flow direction) illustrating the layer configuration in the water electrolysis area 10a where water electrolysis is performed.

The water electrolysis cell 10 is composed of a plurality of layers, and one of them becomes an oxygen electrode (anode) and the other becomes a hydrogen electrode (cathode) with the solid polymer electrolyte membrane 11 sandwiched therebetween.

In the water electrolysis area 10a, as shown in FIG. 2, the anode is laminated in this order from the solid polymer electrolyte membrane 11 side to the anode catalyst layer 12, the anode gas diffusion layer 13, and the anode separator 14. On the other hand, the cathode includes a cathode catalyst layer 15, a cathode gas diffusion layer 16, and a cathode separator 17 in this order from the side of the solid polymer electrolyte membrane 11 Here, the water electrolyte membrane electrode assembly means a stack of a solid polymer electrolyte membrane 11, an anode catalyst layer 12 disposed on an anode side of the solid polymer electrolyte membrane 11, and a cathode catalyst layer 15 disposed on a cathode side of the solid polymer electrolyte membrane 11 The thickness of the water electrolysis membrane electrode assembly is typically about 0.4 mm, and the thickness of the water electrolysis cell 10 in the water electrolysis area 10a is typically about 1.3 mm

### 1.1. Solid Polymer Electrolyte Membrane

The solid polymer electrolyte membrane 11 is an embodiment of an electrolyte membrane having proton conductivity. The material (electrolyte) constituting the solid polymer electrolyte membrane 11 in this form is a solid polymer material, and examples thereof include a proton conductive ion exchange membrane formed of a fluorine-based resin, a hydrocarbon-based resin material, or the like. It exhibits good proton conductivity (electrical conductivity) in the wet state. More specific examples thereof include a membrane made of Nafion (Nafion, registered trademark) which is a perfluoro-based electrolyte.

The thickness of the solid polymer electrolyte membrane 11 is not particularly limited, but, in some embodiments, is 200 μm or less, 100 μm or less, or 30 μm or less.

### 1.2. Anode Catalyst Layer

The anode catalyst layer (oxygen electrode catalyst layer) 12 is a catalyst layer having a catalyst containing at least one or more of a noble metal catalyst such as Pt, Ru, Ir and an oxide thereof. More specific examples of the catalyst include Pt, iridium oxide, ruthenium oxide, iridium ruthenium oxide, or mixtures thereof.

Examples of the iridium oxide include iridium oxide (IrO₂, IrO₃), iridium tin oxide, and iridium zirconium oxide.

Examples of the ruthenium oxide include ruthenium oxide (RuO₂, Ru₂O₃), ruthenium tantalum oxide, ruthenium zirconium oxide, ruthenium titanium oxide, and ruthenium titanium cerium oxide.

Examples of the iridium ruthenium oxide include iridium ruthenium cobalt oxide, iridium ruthenium tin oxide, iridium ruthenium iron oxide, and iridium ruthenium nickel oxide.

The anode catalyst layer 12 may include an ionomer. In addition to improving coatability by including an ionomer, transmission of water supplied during water splitting can be smoothly performed due to its hydrophilicity. Examples of the ionomer to be included include an ionomer containing a perfluoro electrolyte which is an electrolyte used in a solid polymer electrolyte membrane.

### 1.3. Anode Gas Diffusion Layer

The anode gas diffusion layer 13 is a gas diffusion layer disposed on the anode side, it is possible to use known ones, is constituted by a member having a gas permeability and conductivity. Specific examples thereof include a porous conductive member made of a sintered body such as metal fibers (e.g., titanium fibers) or metal particles (titanium particles)

### 1.4. Anode Separator

The anode separator 14 is a member (separator) including a channel (water supply channel for water electrolysis) 14a through which pure water and decomposed oxygen to be supplied to the anode gas diffusion layer 13 flow. The anode separator 14 in this embodiment is a member unevenness is repeated to form a plate-like member in the water electrolysis area 10a is placed in contact with the anode gas diffusion layer 13, the anode gas diffusion layer 13 and the convex portion 14b water electrolysis water supply flow path 14a is formed between.

Anode separator 14 can be made by, for example, press molding a titanium thin film, the plate thickness is typically 0.1 mm to 0.2 mm, the height of the unevens is typically 0.5 mm degree.

Incidentally, the recessed 14c forms a flow path through which the coolant flows when the water-electrolyzed stack as will be described later.

In addition, the anode separator 14 has an oxygen electrode introduction hole 10b, an oxygen electrode derivation hole 10c, a hydrogen electrode derivation hole 10d, a cooling fluid introduction hole 10e, and a cooling fluid derivation hole 10f as shown in FIG. 1 and described above.

### 1.5. Cathode Catalyst Layer

The cathode catalyst layer 15 is a catalyst layer containing a catalyst, and a catalyst contained in the cathode catalyst layer 15 may be a known catalyst, and examples thereof include platinum, platinum coated titanium, platinum supported carbon, palladium supported carbon, cobalt trioxime, and nickel glyoxime.

The cathode catalyst layer 15 may include an ionomer. By including an ionomer, coatability can be improved. Examples of the ionomer to be included include an ionomer comprising a perfluoro electrolyte which is an electrolyte used in a solid polymer electrolyte membrane.

### 1.6. Cathode Gas Diffusion Layer

Cathode gas diffusion layer 16 is a gas diffusion layer disposed on the cathode side, it is possible to use known ones, is constituted by a member having a gas permeability and conductivity. Specific examples thereof include porous members such as carbon cloth and carbon paper.

### 1.7. Cathode Separator

The cathode separator 17 is a member including a channel 17a through which hydrogen ions generated by reduction of hydrogen ions and water (accompanying water) accompanying the hydrogen ions permeate through the solid polymer electrolyte membrane 11 reach. Cathode separator 17 in this embodiment is a member unevenness is repeated to form a plate-like member in the water-electrolysis area 10a is placed in contact with the cathode gas diffusion layer 16, the cathode gas diffusion layer 16 and the convex portion 17b flow path 17a for hydrogen discharge is formed between.

The cathode separator 17 can be manufactured, for example, by press-molding a titanium thin film, and the plate thickness thereof is typically 0.1 mm to 0.2 mm, and the height of the unevenness is typically about 0.5 mm

In addition, the cathode separator 17 has an oxygen electrode introduction hole 10b, an oxygen electrode lead-out hole 10c, a hydrogen electrode lead-out hole 10d, a cooling fluid introduction hole 10e, and a cooling fluid lead-out hole 10f as shown in FIG. 1 and described above.

### 1.8. Layer Configuration in the Water Electrolysis Region

As shown in FIG. 2 and FIG. 3, the layer structure of the water-electrolyzed region 10a is such that the anode is laminated in this order from the solid polymer electrolyte membrane 11 side to the anode catalyst layer 12, the anode gas diffusing layer 13, and the anode separator 14. On the other hand, the cathode includes a cathode catalyst layer 15, a cathode gas diffusion layer 16, and a cathode separator 17 in this order from the side of the solid polymer electrolyte membrane 11

The anode separator 14 includes a channel (water supply channel for water electrolysis) 14a through which pure water and generated oxygen are supplied to the anode gas diffusion layer 13 In this embodiment, the anode separator 14 forms a plate-like member in a wavy shape in the water electrolysis area 10a and unevens are repeated, by the recess 14c is disposed in contact with the anode gas diffusion layer 13, the anode gas diffusion layer 13 and the convex portion 14b water electrolysis water supply flow path 14a is formed between.

The cathode separator 17 includes a channel 17a through which hydrogen ions generated by reduction of hydrogen ions and water (accompanying water) accompanying the hydrogen ions permeate through the solid polymer electrolyte membrane 11 reach. Cathode separator 17 in the present embodiment is repeated irregularities to form a plate-like member in the water-electrolysis area 10a, by the recess 17c is disposed in contact with the cathode gas diffusion layer 16, the cathode gas diffusion layer 16 and the convex portion 17b flow path 17a for hydrogen discharge is formed between.

### 1.9. Generating of Hydrogen and Oxygen

According to the water electrolysis cell 10 of the present disclosure, it acts, for example, as follows.

When feed water for water electrolysis is supplied from the oxygen electrode-side inlet manifold 10b, the feed water for water electrolysis reaches the water electrolysis area 10a In the water electrolysis region 10a, the water electrolysis supply water (H₂O) supplied from the water electrolysis water supply channel 14a to the anode (oxygen electrode) is decomposed into oxygen, electrons and protons (H⁺) in the anode catalyst layer 12 having a potential by energizing between the anode and the cathode. At this time, protons pass through the solid polymer electrolyte membrane 11 and move to the cathode catalyst layer 15 On the other hand, electronics separated by the anode catalyst layer 12 pass through an external circuit and reach the cathode catalyst layer 15 Then, protons receive electronics in the cathode catalyst layer 15, hydrogen (H₂) is generated, and reaches the cathode gas diffusing layer 16 Incidentally, in the cathode gas diffusion layer 16 accompanied water is present together with the generated hydrogen gas.

Hydrogen gas and associated water present in the cathode gas diffusion 16 reaches the cathode separator 17, it flows through the flow path 17a is discharged from the hydrogen electrode-side outlet manifold 10d (hydrogen electrode outlet hole).

On the other hand, the oxygen generated in the anode catalyst layer 12 and the unused residual water return to the anode separator 14 and are discharged from the oxygen electrode outlet manifold 10c through the hydrogen-supply channel 14a

### 2. Water Electrolysis Stack

### 2.1. Basic Structure of the Water Electrolysis Stack

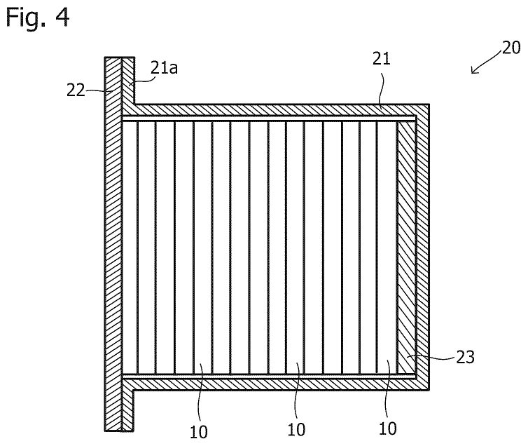

The water electrolysis stack 20 is a member formed by stacking a plurality of (about 50 sheets to about 400 sheets) of the above-described water electrolysis cells 10, and energizes the plurality of water electrolysis cells 10 to generate hydrogen and oxygen. FIG. 4 shows the outline of the structure. The water electrolysis cell 20 includes a stack case 21, an end plate 22, a plurality of water electrolysis cells 10, and a biasing member 23

Stack case 21, a plurality of water electrolysis cells 10 stacked, and a housing for housing the biasing member 23 inside. Stack case 21 in the present embodiment is open at one end in a rectangular tubular shape, together with the other end is closed, the plate-shaped piece on the opposite side to the opening along the edge of the opening overhangs, to form a flanged 21a.

End plate 22 is a plate-like member, closing the opening of the stack case 21. End plate 22 so as to cover the stack case 21 by bolts and nuts or the like overlapping part of the flange 21a of the stack case 21 is fixed to the stack case 21.

The water electrolysis cell 10 is as described above. A plurality of such water electrolysis cells 10 are overlapped. Here, in this form, as can be seen from FIG. 4, the water electrolysis cell 10 is configured to be overlapped horizontally, the water electrolysis cell 10 is arranged so that the direction in which the water supply flow path 14a are aligned and the direction in which the flow path 17a are aligned are the vertical direction as shown in FIG. 1.

Biasing member 23 fits inside the stack case 21, imparts a pressing force to the laminate of the water electrolysis cell 10 in the stacking direction. Examples of the biasing member may include a dish spring.

### 2.2. Laminated Structure of a Water Electrolysis Cell in a Water Electrolysis Stack

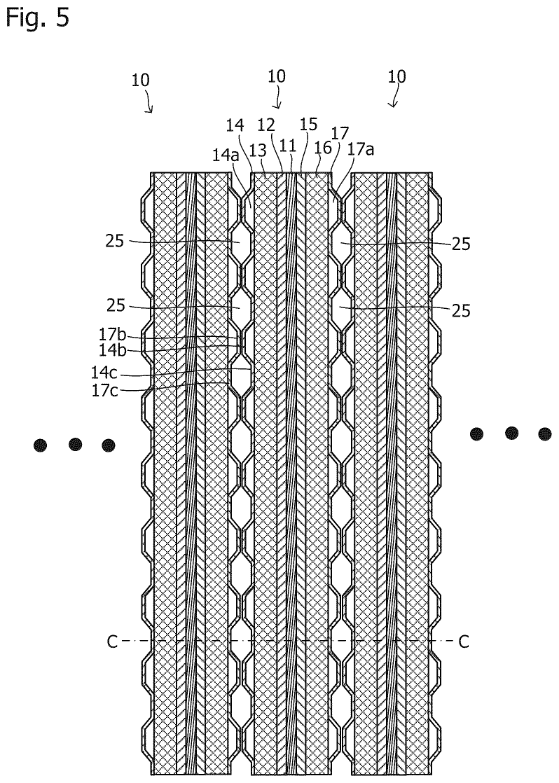

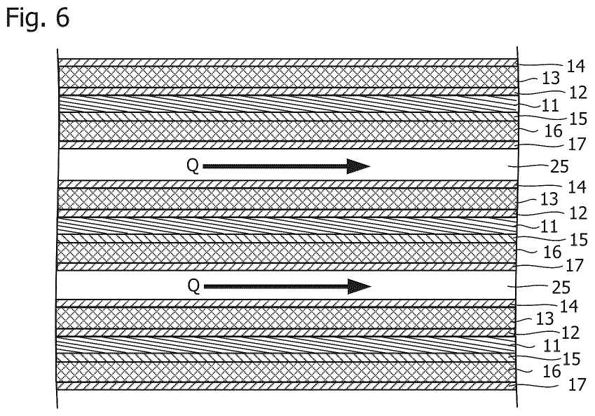

As described above, in the water electrolysis stack 20, a plurality of water electrolysis cells 10 are laminated. In FIG. 5, three of the laminated water electrolysis cell 10 was extracted to represent a cross section of a portion (a portion of the water electrolysis area 10a). Further, FIG. 6 represents a cross-sectional view taken along C-C line in FIG. 5.

As can be seen from FIGS. 5 and 6, when the water electrolysis cell 10 is stacked, the anode separator 14 of one of the water electrolysis cells 10 and the cathode separator 17 of the other water electrolysis cell 10 overlap each other in the adjacent water electrolysis cell 10 More specifically, the convex 14b of the anode separator 14 of one water electrolysis cell 10 and the convex 17b of the cathode separator 17 of the other water electrolysis cell 10 are contacted and overlapped with each other. Similarly, the concave 14c of the anode separator 14 of one water electrolysis cell 10 and the concave 17c of the cathode separator 17 of the other water electrolysis cell 10 are arranged to overlap each other, and the cooling-fluid flow passage 25 is formed here.

In other words, in the water electrolysis stack 20 of the present embodiment, the water electrolysis cell 10 includes a laminate for water electrolysis (a laminate made of a solid polymer electrolyte membrane 11, an anode catalyst layer 12, an anode gas diffusion layer 13, a cathode catalyst layer 15, and a cathode gas diffusion layer 16), and a separator 14, 17, which is flat, has a first surface on a side in contact with a laminate for water electrolysis and a second surface on a side opposite to the first surface, and includes a first flow path (a water supply channel 14a for water electrolysis and a channel 17a) through which water electrolysis is performed The water electrolysis cell is provided with a second flow path through which a cooling fluid (a refrigerant, a liquid, or a gas) is flowed.

Cooling fluid flow path 25, as can be seen from FIGS. 5 and 6, has a flow path which is parallel to the water electrolysis water feed flow path 14a across the anode separator 14. The cooling fluid flow passage 25 has one end leading to the cooling fluid inlet hole (cooling fluid inlet manifold) 10e and the other end leading to the cooling fluid outlet hole (cooling fluid outlet manifold) 10f (see FIG. 1), supplies cooling fluid from the cooling fluid inlet hole 10e, cooling fluid flows through the cooling fluid flow passage 25, and is drained from the cooling fluid outlet hole 10f.

In the water electrolysis stack 20, as described above, in the inside of the water electrolysis cell 10, water supplied from the oxygen electrode introduction hole 10b is decomposed into hydrogen and oxygen, and oxygen and remaining water generated in the supply channel 14a for water electrolysis flow path are discharged from the oxygen electrode lead-out hole 10c by flowing in the directions indicated by arrows P in FIGS. 1 and 3.

Meanwhile, the cooling fluid supplied from the cooling fluid introduction hole 10e flows in the directions indicated by the arrows Q in FIGS. 1, 3, and 6 to cool the oxygen electrode. On the discharge side from the oxygen electrode of the water electrolysis cell, the ratio of the oxygen gas to the supply water for water electrolysis accompanying the generation of oxygen increased, and the cooling effect by the supply water decreased with respect to the inlet side, so that it could not be said that the suppression of the temperature increase of the water electrolysis cell was sufficient. If the temperature of the water electrolysis cell increases too much, the water electrolysis performance decreases. In contrast, in the present embodiment, it becomes possible to cool as necessary for flowing the cooling fluid as described above, it is possible to maintain the water electrolysis performance.

In this form, the flow of the fluid in the supply channel 14a for water electrolysis and the flow of the fluid in the cooling fluid channel 25 are opposed to each other, but the present disclosure is not limited thereto and may be a parallel flow. If the parallel flow, in FIG. 1, it is sufficient to exchange the positions of the cooling water introducing hole 10e and the cooling water outlet hole 10f.

In addition, the entire surface of the flat water electrolysis cell may be cooled by the cooling fluid channel, and a configuration may be employed in which a part of the region is cooled. In some embodiments, cooling in the water electrolysis cell cools the outlet region of the oxygen electrode more than the inlet region.

### 3. Water Electrolyzer Systems

### 3.1. Basic Composition of Water Electrolysis System

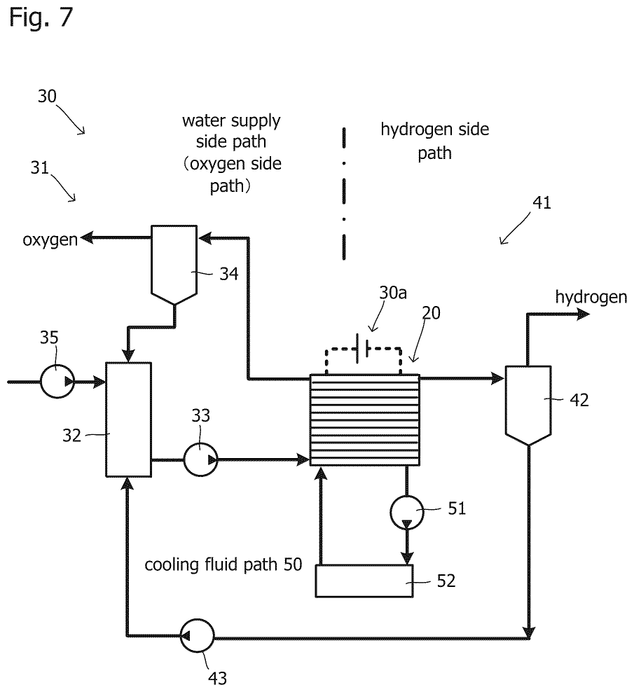

First, the basic configuration of the water electrolysis system will be described. Although the basic configuration of the water electrolysis system is as publicly known, the water electrolysis system 30 including the basic configuration concerned was conceptually shown in FIG. 7 The water electrolysis system 30 has the above-described water electrolysis stack 20, a water supply side path (oxygen side path) 31, and a hydrogen side path 41. In the water electrolysis system 30, water for water electrolysis is supplied from the water supply side path 31 to the water electrolysis stack 12 and energized by the power 30a, whereby water is decomposed into hydrogen and oxygen, and hydrogen is obtained and discharged into the hydrogen side path 41.

Power supply 10a is a DC power supply device for advancing the water electrolysis by applying a voltage to the water electrolysis cell 10 as described above, it can be applied to those provided in a known water electrolysis system.

### [Water Supply Side Route (Oxygen Side Route)].

The water supply side path (oxygen side path) 31 is a path including a pipe for supplying water for water electrolysis to the water electrolysis cell 10 of the water electrolysis stack 20 to obtain oxygen.

In this form, in the water supply side path 31, pure water for water electrolysis stored in the pure water tank 32 is supplied to the water electrolysis stack 20 using the pump 33 as power. If necessary, a condenser for cooling water or an ion exchanger for removing ions contained in water may be disposed between the pump 33 and the water electrolysis stack 20

In the water supply side path 31, further, oxygen generated in the water electrolytic stack 20 and residual water not used are discharged from the water electrolytic stack 20 and supplied to the gas-liquid separator 34. In the gas-liquid separator 34, water and oxygen are separated, and the separated oxygen is discharged and the water is returned to the pure water tank 32. Note that the insufficient water is supplied from the pump 35 to the pure water tank 32.

The above-described devices are connected by pipes to form a fluid path. In addition to the above, known equipment is arranged in the water supply side path 31 as necessary.

### [Hydrogen Side Pathway].

The hydrogen side path 41 is a path including a pipe for taking out hydrogen generated in the water electrolysis stack 20. In the hydrogen side path 41, hydrogen and accompanying water discharged from the water electrolysis cell 10 of the water electrolysis stack 20 are supplied to the gas-liquid separator 42 In the gas-liquid separator 42, water (accompanying water) and hydrogen are separated. Hydrogen separated by the gas-liquid separator 42 is contained in a tank by dehumidifying or the like. The water separated by the gas-liquid separator 42 is sent to the pure water tank 32 of the water supply side path 31 by the pump 43 and is utilized again. At this time, it may be passed through the ion separator before reaching the pure water tank 32 if necessary.

In the hydrogen side path, each of these devices are connected by piping. In addition to the above, known equipment is arranged in the hydrogen side path 41 as needed.

### 3.2. Form 1

In the water electrolysis system 30 according to the form 1, a cooling fluid path 50 is provided as shown in FIG. 7 in addition to the above basic configuration. The cooling fluid path 50 is a path for supplying a cooling fluid to the above-described cooling fluid flow path 25 of the water electrolysis cell 10. The flow mode of the cooling fluid in the water electrolysis cell 10 and its effect are as described above.

The cooling fluid path 50 sends the cooling fluid to the cooler 52 at the pump 51, and the cooling fluid whose temperature is regulated at the cooler 52 is sent to the cooling fluid introduction hole 10e of the water electrolysis cell 10. The cooling fluid subjected to cooling is collected from the cooling fluid outlet hole 10f of the water electrolysis cell 10 and returned to the pumping 51. Each of these devices in the cooling fluid path 50 is connected by a pipe. The cooling fluid path 50 in addition to the above, equipment such as a temperature sensor and a flow sensor or the like are arranged as required.

Adjustment of the cooling capacity by the cooling fluid can be performed by the temperature adjustment by the cooler 52 and the flow rate adjustment by the pump 51. In addition, in this form, the cooling fluid may be pure water or a refrigerant containing ethylene glycol, Propylene Glycol, or the like. This prevents freezing, so it can be applied in cold regions.

### 3.3. Form 2

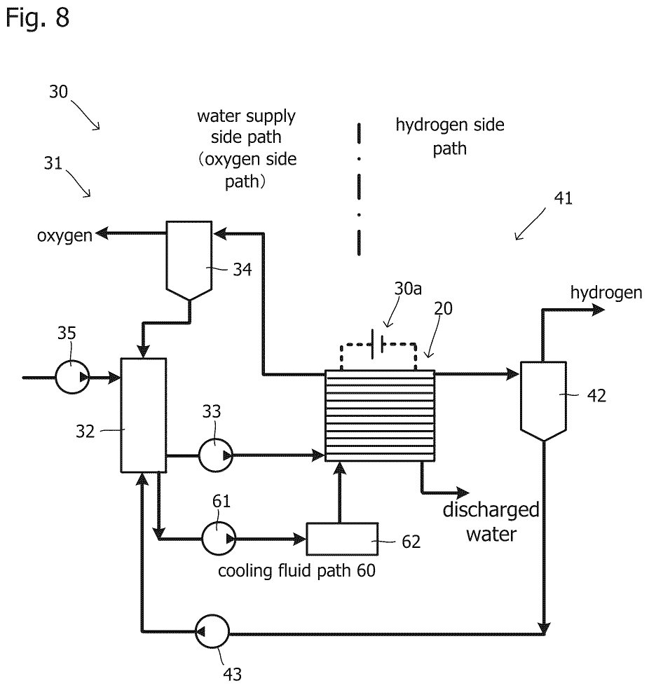

In the water electrolysis system 30 according to the form 2, a cooling fluid path 60 is provided as shown in FIG. 8 in addition to the above basic configuration.

The cooling fluid path 60 is a path for supplying a cooling fluid to the above-described cooling fluid flow path 25 of the water electrolysis cell 10. The flow mode of the cooling fluid in the water electrolysis cell 10 and its effect are as described above.

The cooling fluid path 60 sends the cooling fluid from the pure water tank 32 to the cooler 62 by the pump 61, and the cooling fluid whose temperature is regulated by the cooler 62 is sent to the cooling fluid introduction hole 10e of the water electrolysis cell 10. The cooling fluid subjected to cooling is collected and discharged from the cooling fluid outlet hole 10f of the water electrolysis cell 10. Each of these devices in the cooling fluid path 60 is connected by a pipe. The cooling fluid path 60 in addition to the above, equipment such as a temperature sensor and a flow sensor or the like are arranged as required.

Adjustment of the cooling capacity by the cooling fluid can be performed by the flow rate adjustment by temperature adjustment and the pump 61 by the cooler 62.

Note that, although the cooling fluid after being subjected to cooling is discharged (discarded) here, the present disclosure is not limited thereto, and may be returned to the pure water tank 32 and reused again.

According to this form, it is possible to utilize the water of the water supply side path, there is no need to prepare a separate cooling fluid.

### 3.4. Form 3

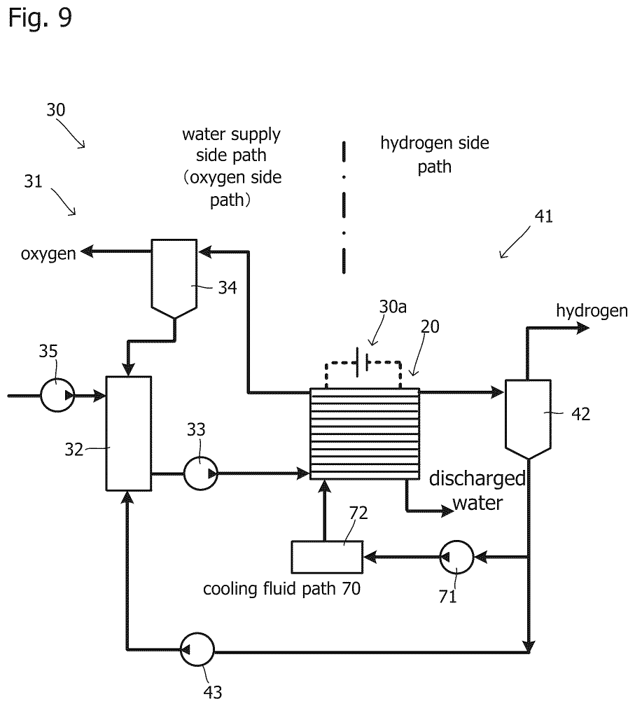

In the water electrolysis system 30 according to the form 3, a cooling fluid path 70 is provided as shown in FIG. 9 in addition to the above basic configuration.

The cooling fluid path 70 is a path for supplying a cooling fluid to the above-described cooling fluid flow path 25 of the water electrolysis cell 10. The flow mode of the cooling fluid in the water electrolysis cell 10 and its effect are as described above.

The cooling fluid passage 70 sends the cooling fluid by the pump 71 from the gas-liquid separator 42 in the hydrogen-side passage to the cooler 72, and the cooling fluid whose temperature is adjusted by the cooler 72 is sent to the cooling fluid introduction hole 10e of the water electrolysis cell 10. The cooling fluid subjected to cooling is collected and discharged from the cooling fluid outlet hole 10f of the water electrolysis cell 10. Each of these devices in the cooling fluid path 70 is connected by a pipe. The cooling fluid path 70 in addition to the above, equipment such as a temperature sensor and a flow sensor or the like are arranged as required.

Adjustment of the cooling capacity by the cooling fluid can be performed by the flow rate adjustment by the temperature adjustment and the pump 71 by the cooler 72.

Note that, although the cooling fluid after being subjected to cooling is discharged (discarded) here, the present disclosure is not limited thereto, and may be returned to the pure water tank 32 and reused again.

According to this form, it is possible to utilize the accompanying water on the hydrogen generating electrode side, and it is not necessary to separately prepare a cooling fluid.

### 3.5. Other

In addition, the entire surface of the flat water electrolysis cell may be cooled by the cooling fluid channel, and a configuration may be employed in which a part of the region is cooled. In some embodiments, cooling in the water electrolysis cell cools the outlet region of the oxygen electrode more than the inlet region.

### REFERENCE SIGNS LIST

10 . . . . Water electrolysis cell, 10a . . . water electrolysis region, 10b . . . oxygen electrode introduction hole, 10d . . . hydrogen electrode lead-out hole, 10f . . . cooling fluid lead-out hole, 11 . . . solid polymer electrolyte membrane, 12 . . . anode catalyst layer, 13 . . . anode gas diffusion layer (oxygen electrode gas diffusion layer), 14 . . . water supply channel for 14a . . . water electrolysis, 15 . . . cathode catalyst layer, 16 . . . cathode gas diffusion layer (hydrogen electrode gas diffusion layer), 17 . . . cathode separator (hydrogen electrode separator), 20 . . . water electrolysis stack, 25 . . . cooling fluid channel, 30. Water Electrolysis System, 50, 60, 70 . . . Cooling Fluid Path

What is claimed is:

1. A water electrolysis system comprising:
a water electrolytic cell comprising an oxygen electrode, and a hydrogen electrode, hydrogen being obtained from the hydrogen electrode by supplying water to the oxygen electrode and applying voltage to the water electrolytic cell; and
a cooling fluid path via which a cooling fluid that is different from the water is supplied to the water electrolytic cell by using a second flow path that is different from a first flow path via which the water is supplied to the oxygen electrode.

2. The water electrolysis system according to claim 1, wherein
a direction in which the cooling fluid flows, and a direction in which the water flows are in a counterflow relationship.

3. The water electrolysis system according to claim 1, wherein
the cooling fluid is accompanying water discharged from the hydrogen electrode.

4. The water electrolysis system according to claim 1, wherein
the cooling fluid is water having branched off from a path that is for supplying the water to the oxygen electrode.

5. The water electrolysis system according to claim 1, wherein
the cooling fluid is water supplied from a gas-liquid separator provided on the hydrogen electrode side.

6. The water electrolysis system according to claim 1, wherein
the water electrolytic cell has a separator in the oxygen electrode, and
the first flow path is formed on a first face of the separator, and the second flow path is formed on a second face that is on an opposite side of the first face.

7. The water electrolysis system according to claim 1, wherein
the first flow path and the second flow path extend in parallel.
